(19) United States
(12) Patent Application Publication
(10) Pub. No.: US 2011/0274156 A1
(43) Pub. Date: Nov. 10, 2011

(54) SYSTEM AND METHOD FOR TRANSMITTING MULTIMEDIA STREAM

(75) Inventors: Farhad Mighani, San Jose, CA (US); Alberto Duenas, Mountain View, CA (US); Nguyen Nguyen, San Jose, CA (US); Gorka Garcia, Madrid (ES)

(73) Assignee: CAVIUM NETWORKS, Mountain View, CA (US)

(21) Appl. No.: 12/774,585

(22) Filed: May 5, 2010

(51) Int. Cl. H04N 7/26; G06F 15/16

(52) U.S. Cl. 375/240.02; 709/231; 375/E07.126

(57) ABSTRACT

Systems and methods for transmitting a multimedia stream are disclosed. A transmitter encodes audio data, video data, and control information received from a source and transmits over a network the different types of data to a receiver coupled to a display. The systems and methods utilize different network queues for the different types of traffic in order to account for differences in quality of service (QoS) parameters. The systems and methods adaptively adjust encoding and transmission parameters based on monitoring changing conditions of the network.

### COPYRIGHT NOTICE

A portion of the disclosure of this patent document contains material that may be subject to copyright protection. The copyright owner has no objection to the facsimile reproduction by anyone of the patent document or the patent disclosure as it appears in the Patent and Trademark Office patent file or records, but otherwise reserves all copyright rights.

### TECHNICAL FIELD

The present application relates to systems and methods for delivering a multimedia stream over a network.

### BACKGROUND

Multimedia streams including audio and video are available from a wide variety of sources, including broadcast television, cable and satellite, digital versatile disc (DVD) players, Blu-ray players, gaming consoles, personal computers, set-top boxes, and the like. Additionally, improvements in audio and video coding techniques coupled with high-speed network connections have made possible new applications such as streaming video, video “place-shifting”, and video on demand (VOD). As the number of sources of video content has increased, so has the number of displays on which to view that content. Advances in display technologies have led to the proliferation of inexpensive consumer devices with video playback capabilities including MP3 players, personal digital assistants (PDAs) and handheld computers, smartphones, and the like. Smaller, lighter displays also afford greater portability for computer monitors and televisions.

Direct-wired connections exist between many conventional sources and displays such as computer-to-monitor or DVD player-to-television. Networked connections exist in limited applications such as video place-shifting wherein, for example, video content from a set-top box is accessible by a personal computer or other device over a network connection. Wireless connectivity between a wide variety of source and display combinations is attractive due to the sheer number of potential source/display pairs and the desire for mobility.

Various wireless solutions exist for transmitting audio streams. Wireless speaker and headphone solutions may utilize, for example, radio frequency (RF) and Bluetooth. Wireless solutions also exist for computer keyboards and mice, either utilizing infra-red (IR) or Bluetooth to transmit control information. Audio data, video data, and control information all have differing requirements with respect to bandwidth, tolerable delay, and error resiliency. What is needed is a wireless solution for transmitting audio streams, video streams, as well as control information such as keyboard and mice commands as well as playback commands from a remote control.

Due to the popularity of WiFi networks, in particular IEEE 802.11 networks, WiFi is one possibility for a wireless solution for transmitting multimedia streams. The wireless solution should possess all the characteristics of wired connectivity with the advantage of mobility. The ideal required characteristics of such a solution are low delay, error resiliency, no perceptible degradation in audio and video quality, and support for end-to-end communication protocols including security protocols such as high-definition content protection (HDCP). For example, a wireless solution could extend high definition multimedia interface (HDMI) connectivity up to 300 feet.

More generally, there is a need for a solution for connecting a wide variety of sources with a wide variety of displays over a network. The ideal solution would optimally utilize the particular characteristics of a specific network, monitor the conditions of the network, and adaptively adjust the encoding parameters of the multimedia stream. It would also optimally prioritize the various types of traffic including audio data, video data, and control information.

### SUMMARY

In one embodiment of the invention, a method of transmitting a multimedia stream over a network is presented. The method involves receiving a multimedia stream from a source, the multimedia stream comprising audio data and video data, determining a first set of video encoding parameters, encoding a first portion of the video data into a first encoded video packet using the first set of video encoding parameters, transmitting the first encoded video packet over a communication link of the network to a receiver through a first network queue, monitoring conditions of the communication link, determining a second set of video encoding parameters based on the conditions of the communication link, encoding a second portion of the video data into a second encoded video packet using the second set of video encoding parameters, and transmitting the second encoded video packet over the communication link to the receiver through the first network queue. The source may be one of a personal computer (PC), notebook computer, network attached storage (NAS) device, portable media device (PMD), smartphone, digital versatile disc (DVD) player, Blu-Ray player, video camera, digital video recorder (DVR), gaming console, set-top box (STB), and the like. The source may output video data of the multimedia stream using one of a high definition multimedia interface (HDMI), DisplayPort interface, digital video interface (DVI), video graphics array (VGA) interface, super-VGA interface, and universal serial bus (USB) interface. The video data may be encoded using one of the MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD video encoding schemes. The source may output audio data of the multimedia stream using one of a high definition multimedia interface (HDMI), a Sony/Philips Digital Interconnect Format (SPDIF) interface, a universal serial bus (USB) interface, or an analog interface. The audio data may be encoded using one of the Advanced Audio Encoding (AAC), Dolby Digital, dts, MPEG-1/2 Layer II (MP2), or MPEG-1 Layer III (MP3) audio encoding schemes. The first set of video encoding parameters may include one or more of bit rate, end-to-end latency, priority and data redundancy. The network may be one of a Bluetooth, an Ethernet, an IEEE 802.11 wireless, a multimedia over coax alliance (MoCA), a power-line, or an ultra-wideband (UWB) network. Monitoring conditions may comprise monitoring latency of the communication link, monitoring the received signal strength indication (RSSI), or monitoring conditions comprises monitoring error rate of packets received by the receiver. The method may further comprise transmitting a first packet of non-video data over the communication link to the receiver through a second network queue. The non-video data may comprise a clock synchronization signal, information related to the output characteristics of the source, or one of infrared (IR) or universal serial bus (USB) commands. The non-video data may also comprise a first encoded audio packet encoded using a first set of audio encoding parameters. In such case, the method may further comprise transmitting a second encoded audio packet encoded using a second set of audio encoding parameters. The second set of audio encoding parameters may be determined based on the conditions of the communication link. The method may also further comprise receiving a first packet of non-video data over the communication link from the receiver through a second network queue. In such case the non-video data may comprise information related to the display capabilities of the display. The method may further comprise adjusting a modulation scheme for the second encoded video packet based on the conditions of the communication link so that it is different from a modulation scheme used to transmit the first encoded video packet. Similarly, the method may further comprise transmitting a second packet of non-video data over the communication link to the receiver through the second network queue. The method may further comprise adjusting a modulation scheme for the second packet of non-video data based on the conditions of the communication link so that it is different from a modulation scheme used to transmit the first packet of non-video data.

In another embodiment of the invention, a system for transmitting a multimedia stream is disclosed. The system comprises a transmitter interfaced to a network and a receiver interfaced to the network. The transmitter comprises an encoder configured to receive from a source a multimedia stream comprising audio data and video data, the encoder being configured to encode a first portion of the video data into a first encoded video packet according to a first set of video encoding parameters and to encode a second portion of the video data into a second encoded video packet according to a second set of video encoding parameters. The transmitter also comprises a transmitter-side network interface coupled to the encoder and configured to send the first encoded video packet and the second encoded video packet over a communication link of the network through a first network queue. The transmitter also comprises a transmitter-side control processor coupled to the encoder and coupled to the transmitter-side network interface, the transmitter-side control processor being configured to monitor conditions of the communication link and to determine the second set of video encoding parameters based on the conditions. The receiver comprises a decoder configured to decode the first encoded video packet and second encoded video packet for display on a display coupled to the receiver. The receiver also comprises a receiver-side network interface coupled to the decoder and configured to receive the first encoded video packet and the second encoded video packet. The receiver also comprises a receiver-side control processor coupled to the decoder and coupled to the receiver-side network interface, the receiver-side control processor being configured to communicate with the transmitter-side control processor over the communication link through a second network queue. The source may be one of a personal computer (PC), notebook computer, network attached storage (NAS) device, portable media device (PMD), smartphone, digital versatile disc (DVD) player, Blu-Ray player, video camera, digital video recorder (DVR), gaming console, or set-top box (STB). The source may output video data of the multimedia stream using one of a high definition multimedia interface (HDMI), DisplayPort interface, digital video interface (DVI), video graphics array (VGA) interface, super-VGA interface, and universal serial bus (USB) interface. The video data may be encoded using one of the MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD video encoding schemes. The source may output audio data of the multimedia stream using one of a high definition multimedia interface (HDMI), a Sony/Philips Digital Interconnect Format (SPDIF) interface, a universal serial bus (USB) interface, or an analog interface. The audio data may be encoded using one of the Advanced Audio Encoding (AAC), Dolby Digital, dts, MPEG-1/2 Layer II (MP2), or MPEG-1 Layer III (MP3) audio encoding schemes. The first set of video encoding parameters may include one or more of bit rate, end-to-end latency, priority and data redundancy. The network may be one of a Bluetooth, an Ethernet, an IEEE 802.11 wireless, a multimedia over coax alliance (MoCA), a power-line, or an ultra-wideband (UWB) network. The transmitter-side control processor may be configured to monitor conditions of the communication link by monitoring one of latency of the communication link, received signal strength indication (RSSI), or error rate of packets received by the receiver. The transmitter may be configured to transmit a first packet of non-video data over the communication link to the receiver through a second network queue. The non-video data may comprise a clock synchronization signal, information related to the output characteristics of the source, or one of infrared (IR) or universal serial bus (USB) commands. The non-video data may also comprise a first encoded audio packet encoded using a first set of audio encoding parameters. In such case, the transmitter may be configured to transmit a second encoded audio packet encoded using a second set of audio encoding parameters and may be configured to determine the second set of audio encoding parameters based on the conditions of the communication link. The transmitter may also be configured to receive a first packet of non-video data over the communication link from the receiver through a second network queue. The non-video data may comprise information related to the display capabilities of the display. The transmitter may also be configured to adjust a modulation scheme for the second encoded video packet based on the conditions of the communication link so that it is different from a modulation scheme used to transmit the first encoded video packet. The transmitter may also be configured to transmit a second packet of non-video data over the communication link to the receiver through the second network queue. In such case, the transmitter may be configured to adjust a modulation scheme for the second packet of non-video data based on the conditions of the communication link so that it is different from a modulation scheme used to transmit the first packet of non-video data.

In another embodiment of the invention, a method of transmitting a multimedia stream over a network is presented. The method involves receiving a multimedia stream from a source, the multimedia stream comprising video data, determining a first set of video encoding parameters, encoding a first portion of the video data into a first encoded video packet using the first set of video encoding parameters, transmitting the first encoded video packet over a communication link of the network to a receiver through a first network queue, monitoring conditions of the communication link, determining a second set of video encoding parameters based on the conditions of the communication link, encoding a second portion of the video data into a second encoded video packet using the second set of video encoding parameters, and transmitting the second encoded video packet over the communication link to the receiver through the first network queue. The source may be one of a personal computer (PC), notebook computer, network attached storage (NAS) device, portable media device (PMD), smartphone, digital versatile disc (DVD) player, Blu-Ray player, video camera, digital video recorder (DVR), gaming console, set-top box (STB), and the like. The source may output video data of the multimedia stream using one of a high definition multimedia interface (HDMI), DisplayPort interface, digital video interface (DVI), video graphics array (VGA) interface, super-VGA interface, and universal serial bus (USB) interface. The video data may be encoded using one of the MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD video encoding schemes. The source may also output audio data of the multimedia stream using one of a high definition multimedia interface (HDMI), a Sony/Philips Digital Interconnect Format (SPDIF) interface, a universal serial bus (USB) interface, or an analog interface. The audio data may be encoded using one of the Advanced Audio Encoding (AAC), Dolby Digital, dts, MPEG-1/2 Layer II (MP2), or MPEG-1 Layer III (MP3) audio encoding schemes. The first set of video encoding parameters may include one or more of bit rate, end-to-end latency, priority and data redundancy. The network may be one of a Bluetooth, an Ethernet, an IEEE 802.11 wireless, a multimedia over coax alliance (MoCA), a power-line, or an ultra-wideband (UWB) network. Monitoring conditions may comprise monitoring latency of the communication link, monitoring the received signal strength indication (RSSI), or monitoring conditions comprises monitoring error rate of packets received by the receiver. The method may further comprise transmitting a first packet of non-video data over the communication link to the receiver through a second network queue. The non-video data may comprise a clock synchronization signal, information related to the output characteristics of the source, or one of infrared (IR) or universal serial bus (USB) commands. The non-video data may also comprise a first encoded audio packet encoded using a first set of audio encoding parameters. In such case, the method may further comprise transmitting a second encoded audio packet encoded using a second set of audio encoding parameters. The second set of audio encoding parameters may be determined based on the conditions of the communication link. The method may also further comprise receiving a first packet of non-video data over the communication link from the receiver through a second network queue. In such case the non-video data may comprise information related to the display capabilities of the display. The method may further comprise adjusting a modulation scheme for the second encoded video packet based on the conditions of the communication link so that it is different from a modulation scheme used to transmit the first encoded video packet. Similarly, the method may further comprise transmitting a second packet of non-video data over the communication link to the receiver through the second network queue. The method may further comprise adjusting a modulation scheme for the second packet of non-video data based on the conditions of the communication link so that it is different from a modulation scheme used to transmit the first packet of non-video data.

In another embodiment of the invention, a system for transmitting a multimedia stream is disclosed. The system comprises a transmitter interfaced to a network and a receiver interfaced to the network. The transmitter comprises an encoder configured to receive from a source a multimedia stream comprising video data, the encoder being configured to encode a first portion of the video data into a first encoded video packet according to a first set of video encoding parameters and to encode a second portion of the video data into a second encoded video packet according to a second set of video encoding parameters. The transmitter also comprises a transmitter-side network interface coupled to the encoder and configured to send the first encoded video packet and the second encoded video packet over a communication link of the network through a first network queue. The transmitter also comprises a transmitter-side control processor coupled to the encoder and coupled to the transmitter-side network interface, the transmitter-side control processor being configured to monitor conditions of the communication link and to determine the second set of video encoding parameters based on the conditions. The receiver comprises a decoder configured to decode the first encoded video packet and second encoded video packet for display on a display coupled to the receiver. The receiver also comprises a receiver-side network interface coupled to the decoder and configured to receive the first encoded video packet and the second encoded video packet. The receiver also comprises a receiver-side control processor coupled to the decoder and coupled to the receiver-side network interface, the receiver-side control processor being configured to communicate with the transmitter-side control processor over the communication link through a second network queue. The source may be one of a personal computer (PC), notebook computer, network attached storage (NAS) device, portable media device (PMD), smartphone, digital versatile disc (DVD) player, Blu-Ray player, video camera, digital video recorder (DVR), gaming console, or set-top box (STB). The source may output video data of the multimedia stream using one of a high definition multimedia interface (HDMI), DisplayPort interface, digital video interface (DVI), video graphics array (VGA) interface, super-VGA interface, and universal serial bus (USB) interface. The video data may be encoded using one of the MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD video encoding schemes. The source may also output audio data of the multimedia stream using one of a high definition multimedia interface (HDMI), a Sony/Philips Digital Interconnect Format (SPDIF) interface, a universal serial bus (USB) interface, or an analog interface. The audio data may be encoded using one of the Advanced Audio Encoding (AAC), Dolby Digital, dts, MPEG-1/2 Layer II (MP2), or MPEG-1 Layer III (MP3) audio encoding schemes. The first set of video encoding parameters may include one or more of bit rate, end-to-end latency, priority and data redundancy. The network may be one of a Bluetooth, an Ethernet, an IEEE 802.11 wireless, a multimedia over coax alliance (MoCA), a power-line, or an ultra-wideband (UWB) network. The transmitter-side control processor may be configured to monitor conditions of the communication link by monitoring one of latency of the communication link, received signal strength indication (RSSI), or error rate of packets received by the receiver. The transmitter may be configured to transmit a first packet of non-video data over the communication link to the receiver through a second network queue. The non-video data may comprise a clock synchronization signal, information related to the output characteristics of the source, or one of infrared (IR) or universal serial bus (USB) commands. The non-video data may also comprise a first encoded audio packet encoded using a first set of audio encoding parameters. In such case, the transmitter may be configured to transmit a second encoded audio packet encoded using a second set of audio encoding parameters and may be configured to determine the second set of audio encoding parameters based on the conditions of the communication link. The transmitter may also be configured to receive a first packet of non-video data over the communication link from the receiver through a second network queue. The non-video data may comprise information related to the display capabilities of the display. The transmitter may also be configured to adjust a modulation scheme for the second encoded video packet based on the conditions of the communication link so that it is different from a modulation scheme used to transmit the first encoded video packet. The transmitter may also be configured to transmit a second packet of non-video data over the communication link to the receiver through the second network queue. In such case, the transmitter may be configured to adjust a modulation scheme for the second packet of non-video data based on the conditions of the communication link so that it is different from a modulation scheme used to transmit the first packet of non-video data.

### BRIEF DESCRIPTION OF DRAWINGS

The foregoing summary, as well as the following detailed description, will be better understood when read in conjunction with the appended drawings. For the purpose of illustrating the invention, there are shown in the drawings examples that are presently preferred. It should be understood, however, that the invention is not limited to the precise arrangements and instrumentalities shown. In the drawings:

FIG. 1 illustrates a system for transmitting a multimedia stream according to an embodiment of the invention;

FIG. 2A illustrates a system for transmitting a multimedia stream according to an embodiment of the invention;

FIG. 2B illustrates a transmitter for transmitting a multimedia stream according to an embodiment of the invention;

FIG. 2C illustrates a receiver for receiving a multimedia stream according to an embodiment of the invention; and

FIG. 3 illustrates a method for transmitting a multimedia stream according to an embodiment of the invention.

### DETAILED DESCRIPTION

Reference will now be made in detail to the present examples of the invention illustrated in the accompanying drawings. Wherever possible, the same reference numbers will be used throughout the drawings to refer to the same or like elements.

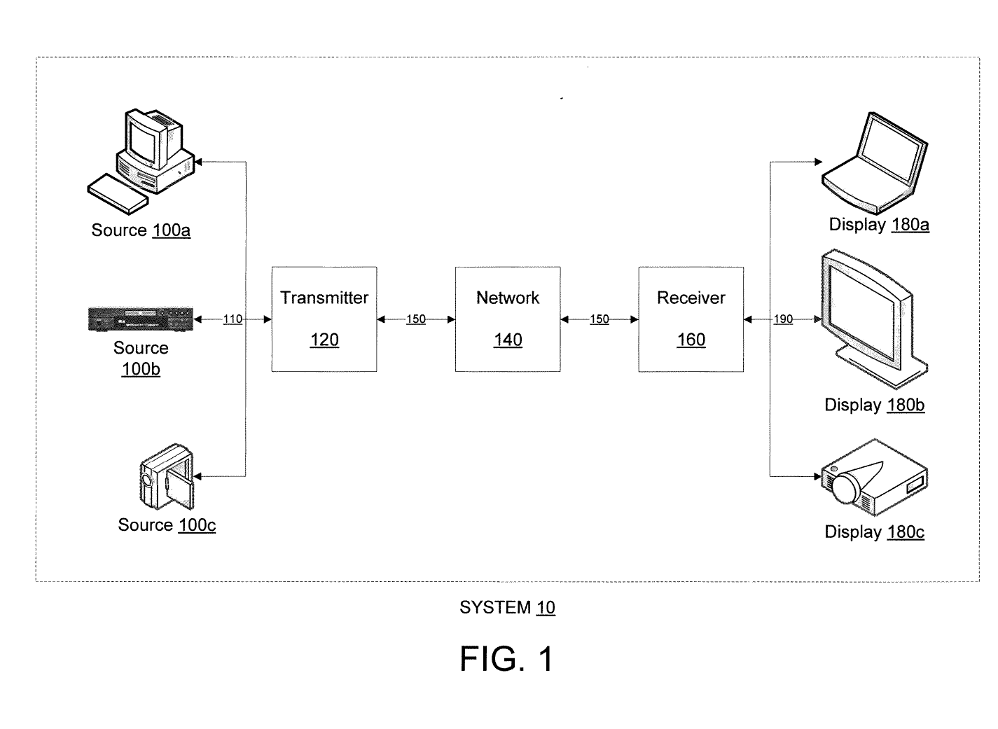

FIG. 1 illustrates a system for transmitting a multimedia stream according to an embodiment of the invention. System 10 comprises a source 100 (shown here as source 100a, source 100b, and source 100c) coupled to a transmitter 120 via link 110. The term “source 100” may refer to any of source 100a, source 100b, or source 100c, either singularly or collectively. Transmitter 120 is coupled to receiver 160 via link 150 on network 140. Receiver 160 is coupled to display 180 (shown here as display 180a, display 180b, and display 180c) via link 190. The term “display 180” may refer to any of display 180a, display 180b, or display 180c, either singularly or collectively.

Source 100 may be any of a variety of sources of multimedia streams including audio data and video data. Examples of source 100 may include a personal computer (PC), notebook computer, network attached storage (NAS) device, portable media device (PMD), smartphone, digital versatile disc (DVD) player, Blu-Ray player, video camera, digital video recorder (DVR), gaming console, cable or satellite set-top box (STB), and the like. Source 100 is coupled to transmitter 120 via link 110, which may be any of a variety of communication links using various interfaces and protocols for transmitting audio data and video data. For example, link 110 may utilize a high definition media interface (HDMI) or other interface such as DisplayPort, digital video interface (DVI), video graphics array (VGA), super-VGA, and the like. Source 100 has particular output characteristics or capabilities and outputs a multimedia stream (not shown) comprising audio data and video data having particular output characteristics. The audio data and video data may be encoded using MPEG, for example, or any of a variety of other audio encoding and video encoding protocols. The video data may also be encoded at a particular resolution such as 480p, 720p, 1080i, and 1080p as well as in a particular format or aspect ratio such as 4:3 or 16:9. The audio data may be encoded into a number of different channels, such as stereo, 2.1, 5.1, and 7.1.

Transmitter 120 is coupled to receiver 160 via link 150 on network 140. Network 140 may be any of a variety of networks utilizing various interfaces and protocols. For example, network 140 may be a power-line network, a coaxial cable network such as a multimedia over coax alliance (MoCA) network, an ISDN network, an Ethernet network, a Bluetooth network, an IEEE 802.11 wireless network, an ultra-wideband (UWB) network, and the like. Link 150 is an appropriate communication link for the particular network 140. For example, link 150 may be a wireless channel on a WiFi network 140.

Receiver 160 is coupled to display 180 via link 190. Display 180 may be any of a variety of displays capable of receiving and displaying audio data and video data. Examples of display 180 may include a television, a cathode ray tube (CRT) monitor, a liquid crystal display (LCD) monitor, a light-emitting diode (LED) monitor, a plasma monitor, a projector, a notebook computer, a portable media device, a smartphone, and the like. Display 180 may also comprise two separate devices, such as an LCD monitor for displaying video data and a speaker system for displaying audio data. Link 190 may be any of a variety of communication links using various interfaces and protocols for transmitting audio data and video data. For example, link 190 may utilize a high definition media interface (HDMI) or other interface such as DisplayPort, digital video interface (DVI), video graphics array (VGA), super-VGA, and the like. Display 180 may have associated display capabilities for displaying audio data and video data. For example, display 180 may be capable of displaying video data at particular resolutions, such as 480p, 720p, 1080i, and 1080p as well as in a particular format or aspect ratio such as 4:3 or 16:9. Display 180 may also be capable of displaying audio data encoded into a number of different channels, such as stereo, 2.1, 5.1, and 7.1. The display capabilities of display 180 may differ from the output characteristics of source 100.

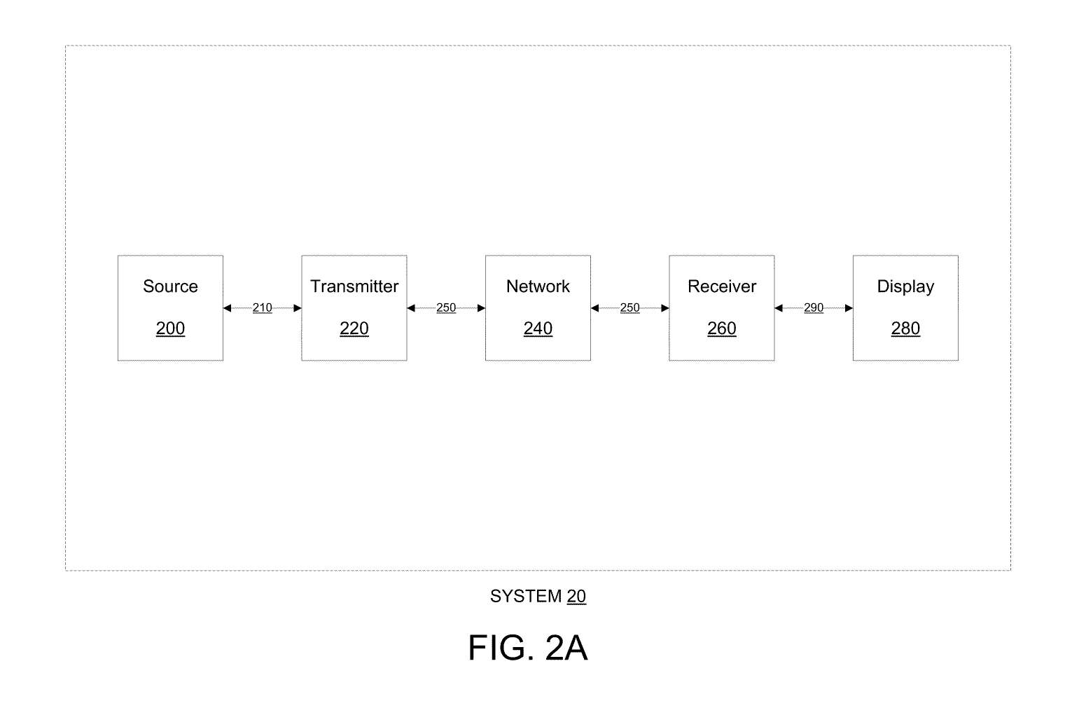

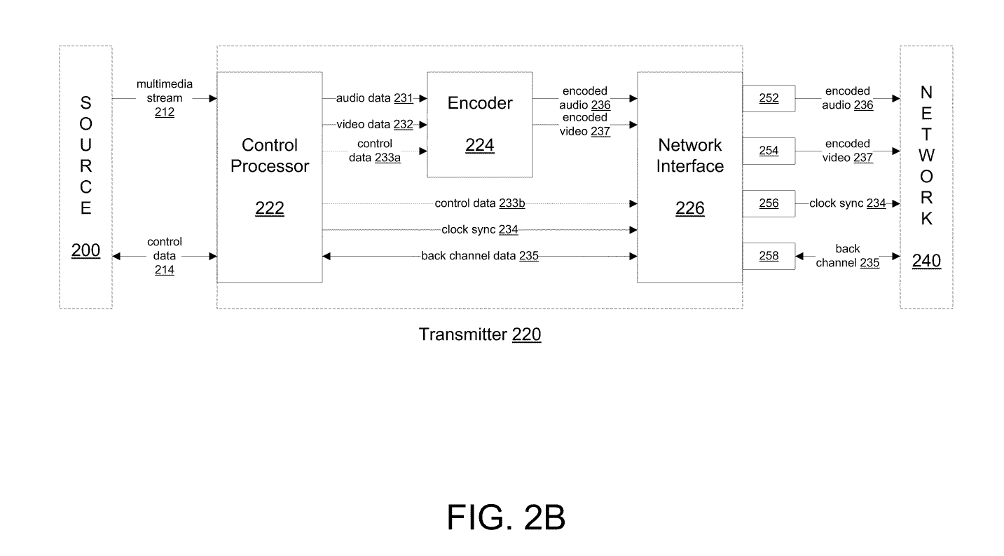

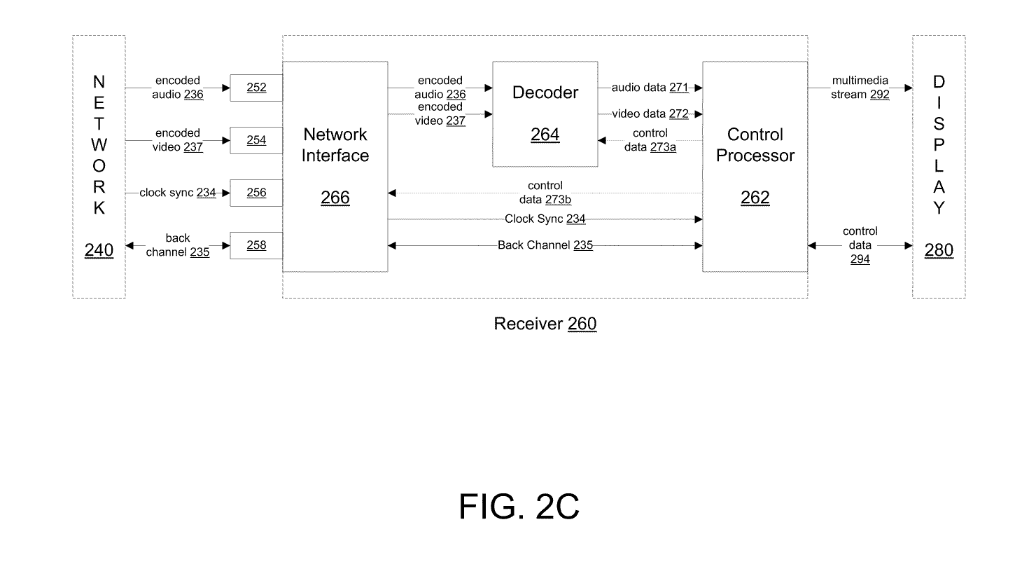

FIG. 2A illustrates a system for transmitting a multimedia stream according to an embodiment of the invention. System 20 comprises a source 200 coupled to a transmitter 220 via link 210. Transmitter 220 is coupled to receiver 260 via link 250 on network 240. Receiver 260 is coupled to display 280 via link 290. Source 200, link 210, transmitter 220, network 240, link 250, display 280, and link 290 correspond to source 100, link 110, transmitter 120, network 140, link 150, display 180, and link 190, respectively of FIG. 1.

FIG. 2B illustrates a transmitter for transmitting a multimedia stream according to an embodiment of the invention. Transmitter 220 is coupled to source 200 and is also coupled to network 240 via link 250 (not shown). Link 250 comprises network queues 252, 254, 256, and 258. Transmitter 220 is interposed between source 200 and network 240. Transmitter 220 comprises control processor 222 coupled to encoder 224, which in turn is coupled to network interface 226. Control processor 222 is also coupled to network interface 226. Network interface 226 is coupled to network 240 via network queues 252, 254, 256, and 258 of link 250 (not shown). Transmitter 220 may comprise a combination of hardware and software modules. For example, control processor 222 may be a general microprocessor, a specialized processor, a programmable module, or application specific integrated circuit (ASIC). Encoder 224 may be implemented as a software module executing on control processor 222 or may be implemented as a dedicated hardware module. Network interface 226 may likewise be implemented as a software module executing on control processor 222 or may be implemented as a dedicated hardware module.

FIG. 2C illustrates a receiver for receiving a multimedia stream according to an embodiment of the invention. Receiver 260 is coupled to network 240 via link 250 (not shown) and is also coupled to display 280. As in FIG. 2B, link 250 comprises network queues 252, 254, 256, and 258. Receiver 260 is interposed between network 240 and display. Receiver 260 comprises control processor 262 coupled to decoder 264, which in turn is coupled to network interface 266. Control processor 262 is also coupled to network interface 266. Network interface 266 is coupled to network 240 via network queues 252, 254, 256, and 258 of link 250 (not shown). Receiver 260 may comprise a combination of hardware and software modules. For example, control processor 262 may be a general microprocessor, a specialized processor, a programmable module, or application specific integrated circuit (ASIC). Decoder 264 may be implemented as a software module executing on control processor 262 or may be implemented as a dedicated hardware module. Network interface 266 may likewise be implemented as a software module executing on control processor 262 or may be implemented as a dedicated hardware module.

Referring now to FIG. 2A, FIG. 2B and FIG. 2C, the operation of system 20 shown in FIG. 2A will now be described. Source 200 outputs a multimedia stream 212 via link 210 to transmitter 220. The multimedia stream 212 comprises audio data and video data and may have been previously encoded using any of a variety of encoding schemes. For example, the video data may have been previously encoded using MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD. The audio data may have been encoded using Advanced Audio Encoding (AAC), Dolby Digital, dts, MPEG-1/2 Layer II (MP2), or MPEG-1 Layer III (MP3). Multimedia stream 212 may have certain characteristics relating to video resolution and aspect ratio as well as audio characteristics as discussed above. Control processor 222 receives multimedia stream 212. Source 200 and control processor 220 also communicate to exchange control data 214. Control data 214 may include, for example, information relating to the characteristics of the multimedia stream 212 such as video resolution and aspect ratio. Control data 214 may also include timing information as well as playback commands (e.g., play, pause, rewind, fast forward, stop). Control data 214 may further include infrared (IR) commands and universal serial bus (USB) command information such as keyboard and mouse commands.

Control processor 222 transmits audio data 231 and video data 232 to encoder 224. Control processor 222 also transmits control data 233a to encoder 224. For example, control data 233a may include encoding parameters for encoder 224 to use. These encoding parameters may include video encoding parameters relating to video frame rate, video bit rate, video resolution and aspect ratio. The encoding parameters may also include audio encoding parameters relating to, for example, audio sampling frequency and audio bit rate. The encoding parameters may also include data redundancy parameters for encoding both audio data and video data, as well as parameters relating to end-to-end latency and priority. Control data 233a may also include instructions for encoder 224, such as to skip or drop a frame, or to change encoding parameters. Control processor 222 may update the control data 233a based on, for example, control data 214 or back channel data 235 as will be described in further detail below. Control processor 222 also transmits control data 233b to network interface 226. For example, control data 233b may include information relating to configuration and utilization of network queues as will be described in further detail below. Control processor 222 also transmits clock sync 234 to network interface 226. Clock sync 234 may be used, for example, to ensure proper synchronization between source 200 and display 280. That is, the internal audio clock and video clock of display 280 must be synchronized with the audio clock and video clock of the incoming multimedia stream as will be described in further detail below. Control processor 222 may generate clock sync 234 or it may derive clock sync 234 from either multimedia stream 212 or control data 214. Control processor 222 also communicates with network interface 226 to exchange back channel data 235. Back channel data 235 may include network statistics or metrics such as channel bit rate, bit error rate (BER), and received signal strength indication (RSSI). Back channel data 235 may also include control data 214. Back channel data 235 may also include information received from receiver 260 as will be described in further detail below.

Encoder 224 encodes audio data 231 and video data 232 into encoded audio 236 and encoded video 237, respectively, according to control data 233. Encoder 224 may utilize, for example, an H.264 encoding scheme, or any of a number of known encoding schemes and protocols. The encoding process may result in a change to one or more of the video frame rate, video bit rate, video resolution, aspect ratio, audio sampling frequency, and audio bit rate. Additionally, the encoding process may also change audio and video data redundancy and end-to-end latency. This is due to the possible differences between the output characteristics of source 200 and the display capabilities of display 280 as well as limitations of the network 240.

Network interface 226 receives encoded audio 236 and encoded video 237 from encoder 224. Network interface 226 also receives clock sync 234 from control processor 222. Network interface 226 also communicates with control processor 222 to exchange back channel data 235. In this example, network interface 226 may utilize network queues 252, 254, 256, and 258 to transmit encoded audio 236, encoded video 237, clock sync 234, and a portion of back channel data 235.

Network queues 252, 254, 256, and 258 may have different characteristics relating to, for example, priority and robustness. That is, network queues 252, 254, 256, and 258 may have different quality of service (QoS) parameters, including settings for automatic repeat-request (ARQ) as well as modulation scheme. In this way, the different types of data traffic may be assigned to different network queues based on the requirements of the particular data. For example, clock sync 234 requires a very predictable inter-arrival period with minimum delay variation. Accordingly, there should not be any ARQ and the lowest modulation scheme should be used. Back channel data 235 requires guaranteed delivery and may rely on upper layer protocols (i.e., TCP). ARQ may be used with this traffic type. Encoded audio 236 and encoded video 237 are somewhat time-sensitive and require low bit error rate. Accordingly, ARQ can be used and set to a predetermined number of retries. As between audio and video, audio traffic is more sensitive to errors and thus may require a higher ARQ setting.

In this example, the transmitter 220 utilizes four network queues 252, 254, 256, and 258. Control processor 222 may map different traffic types into pre-existing queues in a particular network device (e.g., in a wireless router) or it may configure queues in the device by sending control data 233b to network interface 226. Network interface 226 may utilize any number of network queues as may be utilized on the network 240 and particular network devices used. For example, if fewer than four network queues are available, both encoded audio 236 and encoded video 237 may be transmitted through a single network queue. Similarly, a class of data traffic may be further sub-divided into multiple queues. For example, back channel data 235 may be divided into two network queues since information relating to source and display characteristics and capabilities are delay-insensitive, while other back channel data, such as IR and USB commands, require low delay.

Receiver 260 receives clock sync 234, back channel data 235, encoded audio 236, and encoded video 237 from transmitter 220 through network queues 252, 254, 256, and 258 of link 250 (not shown) on network 240. Network interface 266 transmits encoded audio 236 and encoded video 237 to decoder 264 for decoding. Network interface 266 transmits clock sync 234 to control processor 262. Network interface 266 also communicates with control processor 262 to exchange back channel data 235. Back channel data may include information transmitted from receiver 260 back to transmitter 220. For example, receiver 260 may transmit back channel data 235 including network statistics or metrics, such as bit error rate (BER), as well as information identifying specific data packets that were lost. Control processor 222 may utilize such back channel data 235 to adjust the encoding parameters used by encoder 224. For example, if the bit error rate (BER) is too high, then control processor 222 may adjust the encoding parameters to utilize a lower bit rate or to increase redundancy. Control processor 222 may also instruct encoder 224 to skip, drop, or re-transmit specific data packets based on back channel data 235 received from receiver 260. Back channel data 235 may also include control data 294. Receiver 260 may also transmit portions of control data 294 to transmitter 220. For example, control data 294 may include information relating to the display capabilities of display 280. The control processor 222 may use this information to determine the encoding parameters for the encoder 224 with respect to, for example, video resolution and aspect ratio. Network interface 266 also receives control data 273b from control processor 262. As one example, control processor 262 may transmit control data 273b instructing network interface 266 to operate using a different modulation scheme, based on instructions received from control processor 222 as part of back channel data 235.

Decoder 264 decodes encoded audio 236 and encoded video 237 into audio data 271 and video data 272, respectively. Decoder 264 also receives control data 273a from control processor 262. For example, control data 273a may include encoding parameters for decoder 264 to use. These decoding parameters may include video decoding parameters relating to video frame rate, video bit rate, video resolution and aspect ratio. The decoding parameters may also include audio decoding parameters relating to, for example, audio sampling frequency and audio bit rate. Control data 273 a may also include instructions for decoder 264, such as to skip or drop a frame, or to change decoding parameters. Control processor 262 may update the control data 2373a based on, for example, control data 294 or back channel data 235.

Control processor 262 receives audio data 271 and video data 272 from decoder 264. Control processor 262 also receives clock sync 234 from network interface 266. Control processor 262 uses the clock sync 234 to output multimedia stream 292 comprising audio data 271 and video data 272 to display 280. Control processor 262 also communicates with display 280 to exchange control data 294. Control data 294 may include, for example, information relating to the display capabilities of display 280. Control processor 262 also communicates with network interface 266 to exchange back channel data 235. Back channel data 235 may include control data 294 as well as other information as described above.

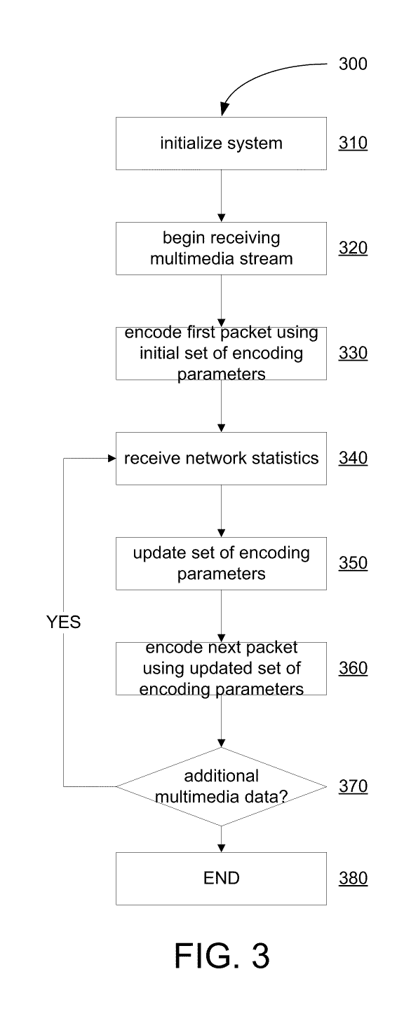

FIG. 3 illustrates a method for transmitting a multimedia stream according to an embodiment of the invention. The method 300 begins with initializing the system at step 310. Initializing the system may include, for example, exchanging information relating to the source output characteristics and the display capabilities. For example, source 200 may transmit its output characteristics to transmitter 220 as part of control data 214. Display 280 may transmit its display capabilities to receiver 260 as part of control data 294. Receiver 260 may transmit the display capabilities information to transmitter 220 as part of back channel data 235 utilizing network queue 258. This information relating to the source output characteristics and the display capabilities can be used by the transmitter 220 to determine an initial set of encoding parameters with respect to, for example, video resolution and aspect ratio. The transmitter 220 may also gather network statistics and metrics to determine an initial video encoding bit rate. For example, control processor 222 may measure the round trip time (RTT) of a test packet sent as part of back channel data 235 through network queue 258 to receiver 260. Alternatively, network interface 226 may receive network statistics or metrics from the network 240 and transmit this information to control processor 222. The process continues with receiving the multimedia stream at step 320. In one embodiment, control processor 222 may derive output characteristics of source 200 from the multimedia stream itself and use this information, along with display capabilities information to determine an initial set of encoding parameters. The next step involves encoding a first packet using the initial set of encoding parameters at step 330. As used herein, the term “packet” may refer to one frame or less than one frame of the multimedia stream. Also, the term “packet” may refer to both audio data and video data either separately or in combination. For example, encoder 224 may encode a first frame of audio data 231 and a first frame of video data 232 into a first packet of encoded audio 236 and a first packet of encoded video 237 and transmit these packets to network interface 226 for placement into an appropriate network queue according to control processor 222. The process continues with receiving network statistics at step 340. For example, control processor 222 may measure the round trip time (RTT) of the first packet of encoded audio 236 and/or the first packet of encoded video 237 sent through network queues 252 and 254 to receiver 260. Alternatively, network interface 226 may receive network statistics or metrics from the network 240 and transmit this information to control processor 222. In another example, receiver 260 may transmit back channel data 235 including network statistics or metrics, such as bit error rate (BER), to the transmitter 220. Based on the network statistics received in step 340, the process continues with updating the set of encoding parameters at step 350. For example, control processor 222 may utilize such back channel data 235 to adjust the encoding parameters used by encoder 224. If the bit error rate (BER) is too high, then control processor 222 may adjust the encoding parameters to utilize a lower bit rate or to increase redundancy. The process continues with encoding the next packet using the updated set of encoding parameters at step 360. At step 370, the process determines whether there is additional multimedia data. If yes, then the process loops back to step 340. Otherwise, the process terminates at step 380.

In this manner, the set of encoding parameters may be continuously adjusted based on changing network conditions. The bit rate may be increased or decreased in response to fluctuations in the channel bit rate or bit error rate (BER) observed on the receiver side. Audio and video data redundancy can be adjusted as well in response to BER.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A method of transmitting a multimedia stream over a network, comprising:
receiving a multimedia stream from a source, the multimedia stream comprising audio data and video data;
determining a first set of video encoding parameters;
encoding a first portion of the video data into a first encoded video packet using the first set of video encoding parameters;
transmitting the first encoded video packet over a communication link of the network to a receiver through a first network queue;
monitoring conditions of the communication link;
determining a second set of video encoding parameters based on the conditions of the communication link;
encoding a second portion of the video data into a second encoded video packet using the second set of video encoding parameters; and
transmitting the second encoded video packet over the communication link to the receiver through the first network queue.

2. The method according to claim 1, wherein the source is one of a personal computer (PC), notebook computer, network attached storage (NAS) device, portable media device (PMD), smartphone, digital versatile disc (DVD) player, Blu-Ray player, video camera, digital video recorder (DVR), gaming console, or set-top box (STB).

3. The method according to claim 1, wherein the source outputs video data of the multimedia stream using one of a high definition multimedia interface (HDMI), DisplayPort interface, digital video interface (DVI), video graphics array (VGA) interface, super-VGA interface, and universal serial bus (USB) interface.

4. The method according to claim 1, wherein the video data is encoded using one of the MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD video encoding schemes.

5. The method according to claim 1, wherein the source outputs audio data of the multimedia stream using one of a high definition multimedia interface (HDMI), a Sony/Philips Digital Interconnect Format (SPDIF) interface, a universal serial bus (USB) interface, or an analog interface.

6. The method according to claim 1, wherein the audio data is encoded using one of the Advanced Audio Encoding (AAC), Dolby Digital, dts, MPEG-1/2 Layer II (MP2), or MPEG-1 Layer III (MP3) audio encoding schemes.

7. The method according to claim 1, wherein the first set of video encoding parameters includes one or more of bit rate, end-to-end latency, priority, and data redundancy.

8. The method according to claim 1, wherein the network is one of a Bluetooth, an Ethernet, an IEEE 802.11 wireless, a multimedia over coax alliance (MoCA), a power-line, or an ultra-wideband (UWB) network.

9. The method according to claim 1, wherein monitoring conditions comprises monitoring one of latency of the communication link, received signal strength indication (RSSI), or error rate of packets received by the receiver.

10. The method according to claim 1, further comprising:
transmitting a first packet of non-video data over the communication link to the receiver through a second network queue.

11. The method according to claim 10, wherein the non-video data comprises a clock synchronization signal.

12. The method according to claim 10, wherein the non-video data comprises information related to the output characteristics of the source.

13. The method according to claim 10, wherein the non-video data comprises one of infrared (IR) or universal serial bus (USB) commands.

14. The method according to claim 10, wherein the non-video data comprises a first encoded audio packet encoded using a first set of audio encoding parameters.

15. The method according to claim 14, further comprising:
transmitting a second encoded audio packet encoded using a second set of audio encoding parameters,
wherein the second set of audio encoding parameters is determined based on the conditions of the communication link.

16. The method according to claim 1, further comprising:
receiving a first packet of non-video data over the communication link from the receiver through a second network queue.

17. The method according to claim 16, wherein the non-video data comprises information related to the display capabilities of the display.

18. The method according to claim 1, further comprising:
adjusting a modulation scheme for the second encoded video packet based on the conditions of the communication link so that it is different from a modulation scheme used to transmit the first encoded video packet.

19. The method according to claim 10, further comprising:
transmitting a second packet of non-video data over the communication link to the receiver through the second network queue.

20. The method according to claim 19, further comprising:
adjusting a modulation scheme for the second packet of non-video data based on the conditions of the communication link so that it is different from a modulation scheme used to transmit the first packet of non-video data.

21. A system comprising:
a transmitter interfaced to a network, comprising:
an encoder configured to receive from a source a multimedia stream comprising audio data and video data, the encoder being configured to encode a first portion of the video data into a first encoded video packet according to a first set of video encoding parameters and to encode a second portion of the video data into a second encoded video packet according to a second set of video encoding parameters;
a transmitter-side network interface coupled to the encoder and configured to send the first encoded video packet and the second encoded video packet over a communication link of the network through a first network queue; and
a transmitter-side control processor coupled to the encoder and coupled to the transmitter-side network interface, the transmitter-side control processor being configured to monitor conditions of the communication link and to determine the second set of video encoding parameters based on the conditions; and
a receiver interfaced to the network, comprising:
a decoder configured to decode the first encoded video packet and second encoded video packet for display on a display coupled to the receiver;
a receiver-side network interface coupled to the decoder and configured to receive the first encoded video packet and the second encoded video packet; and
a receiver-side control processor coupled to the decoder and coupled to the receiver-side network interface, the receiver-side control processor being configured to communicate with the transmitter-side control processor over the communication link through a second network queue.

22. The system according to claim 21, wherein the source is one of a personal computer (PC), notebook computer, network attached storage (NAS) device, portable media device (PMD), smartphone, digital versatile disc (DVD) player, Blu-Ray player, video camera, digital video recorder (DVR), gaming console, or set-top box (STB).

23. The system according to claim 21, wherein the source outputs video data of the multimedia stream using one of a high definition multimedia interface (HDMI), DisplayPort interface, digital video interface (DVI), video graphics array (VGA) interface, super-VGA interface, and universal serial bus (USB) interface.

24. The system according to claim 21, wherein the video data is encoded using one of the MPEG-1, MPEG-2, MPEG-4, Motion JPEG (MJPEG), Motion JPEG2000 (MJPEG 2000), audio video standard (AVS), digital video (DV), RealVideo, Windows Media Video (WMV), SMPTE 421M video codec standard (VC-1), DivX, or XviD video encoding schemes.

25. The system according to claim 21, wherein the source outputs audio data of the multimedia stream using one of a high definition multimedia interface (HDMI), a Sony/Philips Digital Interconnect Format (SPDIF) interface, a universal serial bus (USB) interface, or an analog interface.

26. The system according to claim 21, wherein the audio data is encoded using one of the Advanced Audio Encoding (AAC), Dolby Digital, dts, MPEG-1/2 Layer II (MP2), or MPEG-1 Layer III (MP3) audio encoding schemes.

27. The system according to claim 21, wherein the first set of video encoding parameters includes one or more of bit rate, end-to-end latency, priority, and data redundancy.

28. The system according to claim 21, wherein the network is one of a Bluetooth, an Ethernet, an IEEE 802.11 wireless, a power-line, a multimedia over coax alliance (MoCA), or an ultra-wideband (UWB) network.

29. The system according to claim 21, wherein the transmitter-side control processor is configured to monitor conditions of the communication link by monitoring one of latency of the communication link, received signal strength indication (RSSI), or error rate of packets received by the receiver.

30. The system according to claim 21, wherein the transmitter is configured to transmit a first packet of non-video data over the communication link to the receiver through a second network queue.

31. The system according to claim 30, wherein the non-video data comprises a clock synchronization signal.

32. The system according to claim 30, wherein the non-video data comprises information related to the output characteristics of the source.

33. The system according to claim 30, wherein the non-video data comprises one of infrared (IR) or universal serial bus (USB) commands.

34. The system according to claim 30, wherein the non-video data comprises a first encoded audio packet encoded using a first set of audio encoding parameters.

35. The system according to claim 21, wherein the transmitter is configured to transmit a second encoded audio packet encoded using a second set of audio encoding parameters and wherein the transmitter-side control processor is configured to determine the second set of audio encoding parameters based on the conditions of the communication link.

36. The system according to claim 21, wherein the transmitter is configured to receive a first packet of non-video data over the communication link from the receiver through a second network queue.

37. The system according to claim 36, wherein the non-video data comprises information related to the display capabilities of the display.

38. The system according to claim 21, wherein the transmitter is configured to adjust a modulation scheme for the second encoded video packet based on the conditions of the communication link so that it is different from a modulation scheme used to transmit the first encoded video packet.

39. The system according to claim 30, wherein the transmitter is configured to transmit a second packet of non-video data over the communication link to the receiver through the second network queue.

40. The system according to claim 39, wherein the transmitter is configured to adjust a modulation scheme for the second packet of non-video data based on the conditions of the communication link so that it is different from a modulation scheme used to transmit the first packet of non-video data.

41. A method of transmitting a multimedia stream over a network, comprising:
receiving a multimedia stream from a source, the multimedia stream comprising video data;
determining a first set of video encoding parameters;
encoding a first portion of the video data into a first encoded video packet using the first set of video encoding parameters;
transmitting the first encoded video packet over a communication link of the network to a receiver through a first network queue;
monitoring conditions of the communication link;
determining a second set of video encoding parameters based on the conditions of the communication link;
encoding a second portion of the video data into a second encoded video packet using the second set of video encoding parameters; and
transmitting the second encoded video packet over the communication link to the receiver through the first network queue.

42. A system comprising:
a transmitter interfaced to a network, comprising:
an encoder configured to receive from a source a multimedia stream comprising video data, the encoder being configured to encode a first portion of the video data into a first encoded video packet according to a first set of video encoding parameters and to encode a second portion of the video data into a second encoded video packet according to a second set of video encoding parameters;
a transmitter-side network interface coupled to the encoder and configured to send the first encoded video packet and the second encoded video packet over a communication link of the network through a first network queue; and
a transmitter-side control processor coupled to the encoder and coupled to the transmitter-side network interface, the transmitter-side control processor being configured to monitor conditions of the communication link and to determine the second set of video encoding parameters based on the conditions; and
a receiver interfaced to the network, comprising:
a decoder configured to decode the first encoded video packet and second encoded video packet for display on a display coupled to the receiver;
a receiver-side network interface coupled to the decoder and configured to receive the first encoded video packet and the second encoded video packet; and
a receiver-side control processor coupled to the decoder and coupled to the receiver-side network interface, the receiver-side control processor being configured to communicate with the transmitter-side control processor over the communication link through a second network queue.
